(19) United States
(12) Patent Application Publication
(10) Pub. No.: US 2026/0059378 A1
(43) Pub. Date: Feb. 26, 2026

(54) EXENTED USAGE OF PROTECTED MANAGEMENT FRAME

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/292,809

(22) Filed: Aug. 6, 2025

Related U.S. Application Data
(60) Provisional application No. 63/687,157, filed on Aug. 26, 2024.
(60) Provisional application No. 63/687,646, filed on Aug. 27, 2024.
(60) Provisional application No. 63/688,164, filed on Aug. 28, 2024.

(51) Int. Cl. H04W 28/02; H04L 47/2408

(52) U.S. Cl. CPC H04W 28/0268; H04L 47/2408

(57) ABSTRACT

A first electronic device includes a processor, and a transceiver operably coupled to the processor. The transceiver is configured to transmit, to a second electronic device, a first frame including a first indication element indicating a generational capability of the first electronic device. The transceiver is also configured to receive, from the second electronic device, in response to transmitting the first frame, a second frame including a second indication element indicating a generational capability of the second electronic device.

### CROSS-REFERENCE TO RELATED APPLICATION(S) AND CLAIM OF PRIORITY

This application claims priority under 35 U.S.C. § 119 (e) to U.S. Provisional Patent Application No. 63/687,157 filed on Aug. 26, 2024, U.S. Provisional Patent Application No. 63/687,646 filed on Aug. 27, 2024, and U.S. Provisional Patent Application No. 63/688,164 filed on Aug. 28, 2024. The above-identified provisional patent applications are hereby incorporated by reference in their entirety.

### TECHNICAL FIELD

This disclosure relates generally to wireless networks. More specifically, this disclosure relates to extended usage of protected management frames.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for extended usage of protected management frames.

In one embodiment, a first electronic device is provided. The first electronic device includes a processor, and a transceiver operably coupled to the processor. The transceiver is configured to transmit, to a second electronic device, a first frame including a first indication element indicating a generational capability of the first electronic device. The transceiver is also configured to receive, from the second electronic device, in response to transmitting the first frame, a second frame including a second indication element indicating a generational capability of the second electronic device.

In another embodiment, a station (STA) is provided. The STA includes a processor configured to determine a set of two or more quality of service (QoS) profiles. The STA also includes a transceiver operably coupled to the processor. The transceiver is configured to transmit, to an access point (AP), a first frame indicating the QoS profiles in the set, and receive, from the AP, a second frame. The second frame includes one of an acceptance of the set of QoS profiles, a rejection of the set of QoS profiles, and an alternative set of QoS profiles. The transceiver is also configured to transmit, to the AP, a third frame indicating a QoS profile that the STA intends to activate based on receipt of the second frame.

In yet another embodiment, an AP is provided. The AP includes a transceiver configured to receive, from a STA, a first frame indicating a set of two or more QoS profiles. The AP also includes a processor operably coupled to the transceiver. The processor is configured to one of (i) accept the set of QoS profiles, (ii) reject the set of QoS profiles, and (iii) identify an alternative set of QoS profiles. The transceiver is also configured to transmit, to the STA, a second frame. The second frame includes one of an acceptance of the set of QoS profiles, a rejection of the set of QoS profiles, and the alternative set of QoS profiles. The transceiver is also configured to receive, from the STA, a third frame indicating a QoS profile that the STA intends to activate based on the second frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example of a generational capability indication element according to embodiments of the present disclosure;

FIG. 5 illustrates an example process for IEEE generational capability indication element exchange according to embodiments of the present disclosure;

FIG. 6 illustrates an example process for sharing IEEE generational capability information during an association phase according to embodiments of the present disclosure;

FIG. 7 illustrates an example process for sharing IEEE generational capability in a probe request frame according to embodiments of the present disclosure;

FIG. 8 illustrates an example process for sending IEEE generational capability information using a protected management frame according to embodiments of the present disclosure;

FIG. 9 illustrates an example process for WFA generational capability indication element exchange according to embodiments of the present disclosure;

FIG. 10 illustrates an example process for sharing WFA generational capability information during an association phase according to embodiments of the present disclosure;

FIG. 11 illustrates an example process for sharing WFA generational capability in a probe request frame according to embodiments of the present disclosure;

FIG. 12 illustrates an example process for sending WFA generational capability information using a protected management frame according to embodiments of the present disclosure;

FIG. 13 illustrates an example of a generational capability indication element that also includes Wi-Fi Alliance generational certification according to embodiments of the present disclosure;

FIG. 14 illustrates an example process for setting up management frame protection before sending a robust generational capability frame according to embodiments of the present disclosure;

FIG. 15 illustrates an example process for soliciting generational capability information from a STA;

FIG. 16 illustrates an example of dynamic switching among different QoS profiles within dynamic SCS according to embodiments of the present disclosure;

FIG. 17 illustrates an example of using SCS request/response for setting up dynamic SCS according to embodiments of the present disclosure;

FIG. 18 illustrates an example of using D-SCS request/response for setting up dynamic SCS according to embodiments of the present disclosure;

FIG. 19 illustrates an example of dynamic profile change based on SCS ID according to embodiments of the present disclosure;

FIGS. 20A and 20B illustrate an example of a format for a D-SCS request frame according to embodiments of the present disclosure;

FIG. 21 illustrates an example of a format for a D-SCS descriptor element according to embodiments of the present disclosure;

FIG. 22 illustrates an example of a format for a D-SCS profile element according to embodiments of the present disclosure;

FIG. 23 illustrates another example of a format for a D-SCS descriptor element according to embodiments of the present disclosure;

FIG. 24 illustrates an example of a format for a profile ID-QoS duple field according to embodiments of the present disclosure;

FIG. 25 illustrates another example of a format for a D-SCS request frame according to embodiments of the present disclosure;

FIG. 26 illustrates another example of a format for a D-SCS descriptor element according to embodiments of the present disclosure;

FIG. 27 illustrates an example method for extended usage of a protected management frame according to embodiments of the present disclosure; and

FIG. 28 illustrates an example method for a dynamic stream classification service request according to embodiments of the present disclosure.

### DETAILED DESCRIPTION

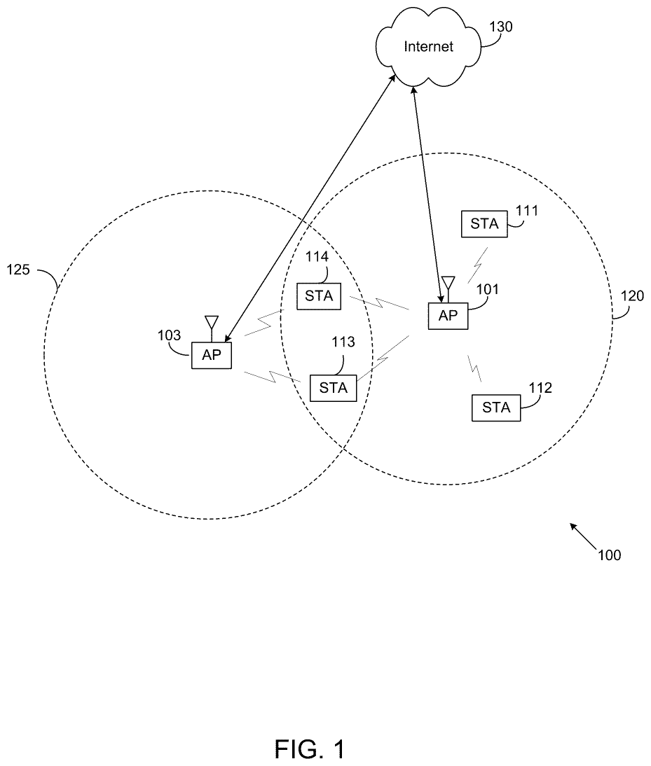

FIGS. 1 through 28, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

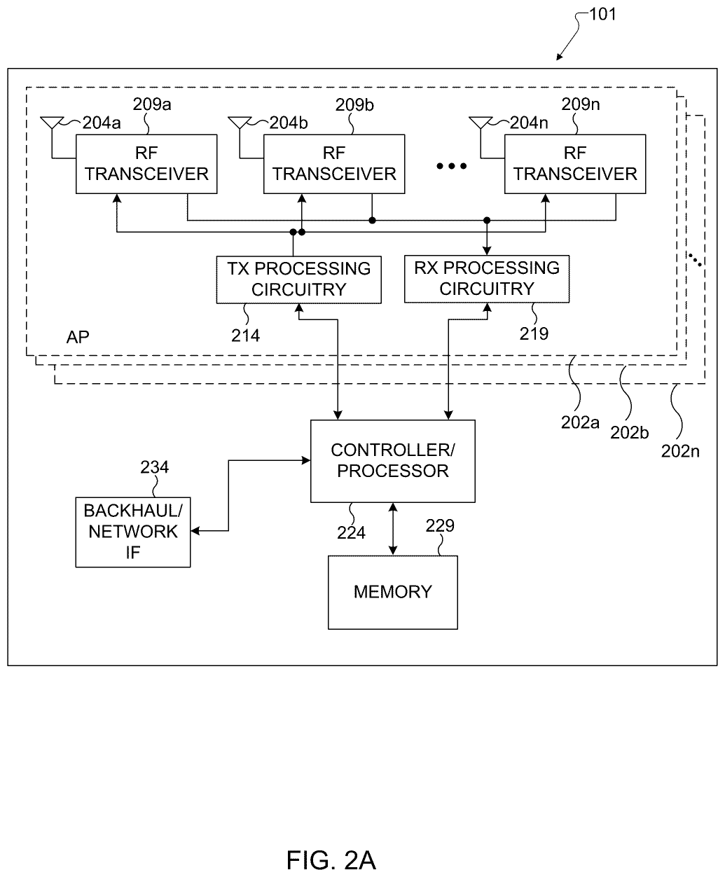

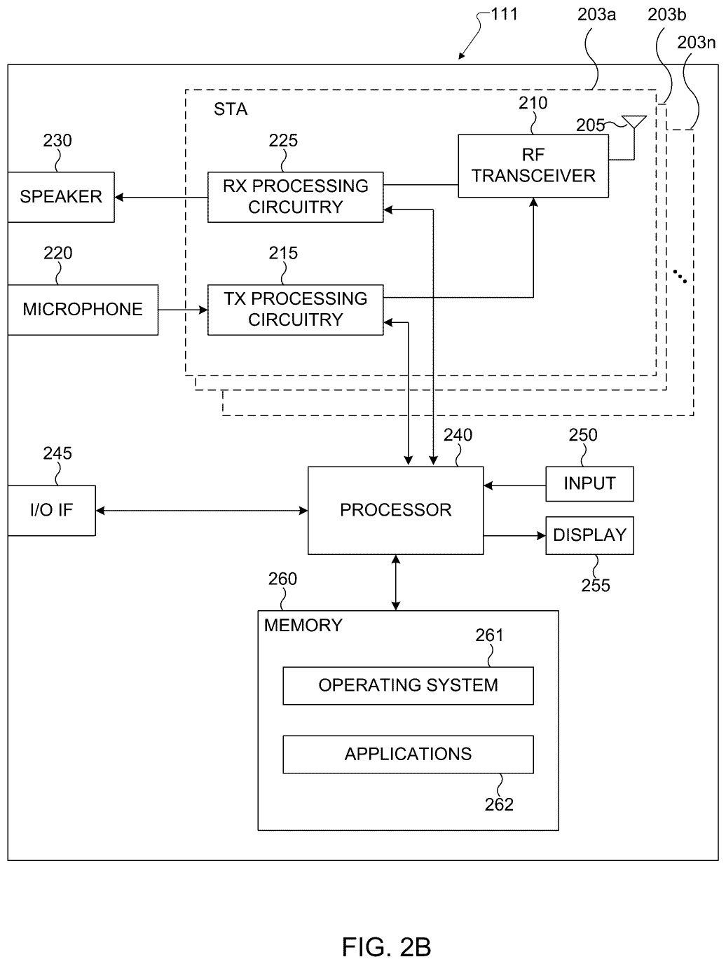

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

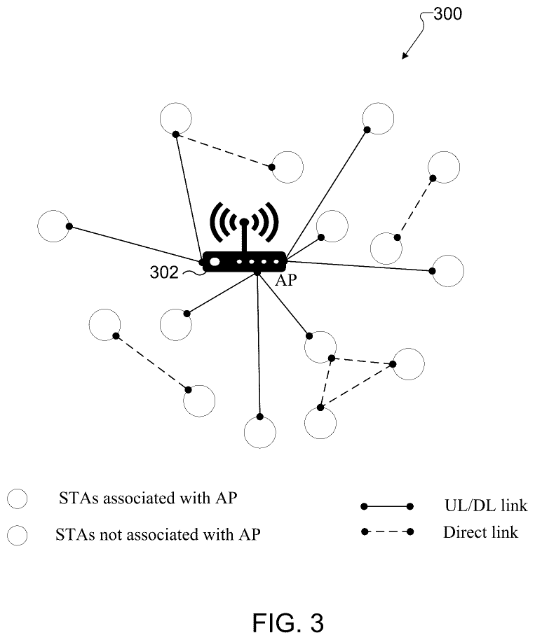

Better support for low-latency applications is desirable in next generation WLAN systems. It is not uncommon to observe numerous devices operating on the same wireless network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS). Some of the unmanaged traffic that interferes with the AP's BSS's latency sensitive traffic may come from uplink (UL)/downlink (DL) or direct link communications within the infrastructure BSS that the AP manages. Other interference with the AP's BSS's latency sensitive traffic may be due to transmission in a neighboring infrastructure (overlapping) BSS (OBSS). Yet other interference with the AP's BSS's latency sensitive traffic may come from a neighboring independent BSS or P2P network as shown in FIG. 3.

FIG. 3 illustrates an example wireless network 300 where infrastructure traffic and non-infrastructure traffic coexist according to embodiments of the present disclosure. The embodiment of a wireless network of FIG. 3 is for illustration only. Different embodiments of a wireless network where infrastructure traffic and non-infrastructure traffic coexist could be used without departing from the scope of this disclosure.

In the example of FIG. 3, an AP 302 is associated with several STAs. The traffic between the AP and associated STAs is infrastructure traffic with respect to the network of AP 302. FIG. 3 also shows several STAs not associated with AP 302. Traffic generated by or transmitted to the STAs not associated with AP 302 is non-infrastructure traffic with respect to the network of AP 302.

Although FIG. 3 illustrates an example wireless network 300 where infrastructure traffic and non-infrastructure traffic coexist, various changes may be made to FIG. 3. For example, FIG. 3 could include additional APS, fewer or more STAs, etc. according to particular needs.

In existing wireless networks, an AP or non-AP STA may support at least one of the following generations of Institute of Electrical and Electronics Engineers (IEEE) wireless networking standards:
IEEE 802.11n
IEEE 802.11ac
IEEE 802.11ax
IEEE 802.11bn.

If a STA could provide this IEEE generational capability-related information to the AP, this could help the AP to better support the non-AP STA. However, currently, there is no mechanism for a STA to convey this information to the AP in a manner that does not violate the non-AP STA's privacy.

Various embodiments of the present disclosure provide mechanisms and frameworks that enable a non-AP STA to convey the non-AP STA's capability to support different versions of IEEE wireless networking standards.

In existing wireless networks, an AP or non-AP STA may support at least one of the following generations of WiFi Alliance (WFA) wireless networking standards:
Wi-Fi 4
Wi-Fi 5
Wi-Fi 6
Wi-Fi 7.

If a STA could provide this WFA generational capability-related information to the AP, this could help the AP to better support the non-AP STA. However, currently, there is no mechanism for a STA to convey this information to the AP in a manner that does not violate the non-AP STA's privacy.

Similarly, a STA may be Wi-Fi Certified for different WFA wireless networking standards as described above. However, currently, there is no mechanism to inform the AP about the STA's certification status in a protected manner.

Various embodiments of the present disclosure provide mechanisms and frameworks that enable a non-AP STA to convey the non-AP STA's capability to support different versions of wireless networking standards, which may include:
Different IEEE 802.11 generations support
Different Wi-Fi Alliance generations support
Different Wi-Fi Alliance generations certification.

Existing wireless networks support a stream classification services (SCS) procedure where a quality of service (QoS) can be included in SCS Request and SCS Response frames. In the existing procedure, the non-AP STA sends to the AP the SCS request with the QoS characteristics element, where the non-AP STA indicates its traffic flow characteristics. The AP reviews the SCS request received from the non-AP STA and, upon acceptance, provisions resources to the non-AP STA based on the traffic characteristics described in the QoS characteristics element included in the SCS request. However, the existing SCS with QoS characteristics procedure is for Quasi-static traffic flow (i.e., the underlying assumption is that the traffic characteristics do not change too frequently). However, there are many scenarios where the users' traffic patterns change frequently, for example—
Content-sharing applications: During Webex, Zoom or other video or live content-sharing applications, the codec rate can change dynamically. Based on the changes in the codec rate, the traffic characteristics also change.
Extended Reality (XR) applications: In various XR applications, the pose data from the hand-held device often needs to be transmitted to either the head-mounted device (HMD) or to the companion device in a very short time (highly latency sensitive) in order to ensure a smooth XR experience. This requires a fast/dynamic change in the QoS characteristics between the hand-held device and the HMD or the companion device.

Existing wireless networks do not include a mechanism that would allow for a non-AP STA to dynamically change SCS setup from one QoS profile to another QoS profile. Specifically, the negotiation process does not include a mechanism to send a request to set up dynamic SCS. This may disrupt the latency sensitive applications for the clients.

Various embodiments of the present disclosure provide mechanisms to set up dynamic SCS between an AP and a non-AP STA or between any two STAs (AP or non-AP STAs).

As noted above, various embodiments of the present disclosure provide mechanisms and frameworks that enable a non-AP STA to convey the non-AP STA's capability to support different versions of wireless networking standards.

In some embodiments, a first STA can indicate its support of different generations of IEEE wireless networking standards to a second STA, where the first STA can be either an AP or a non-AP STA, and the second STA can also be either an AP or a non-AP STA.

In some embodiments, if a first STA intends to indicate the first STA's IEEE generational support to a second STA, then the first STA can send an IEEE generational capability indication element to the second STA. In this element, the first STA can indicate the first STA's IEEE generational capabilities such as whether the first STA supports IEEE 802.11n, IEEE 802.11ac, IEEE 802.11ax, or IEEE 802.11bn, etc.

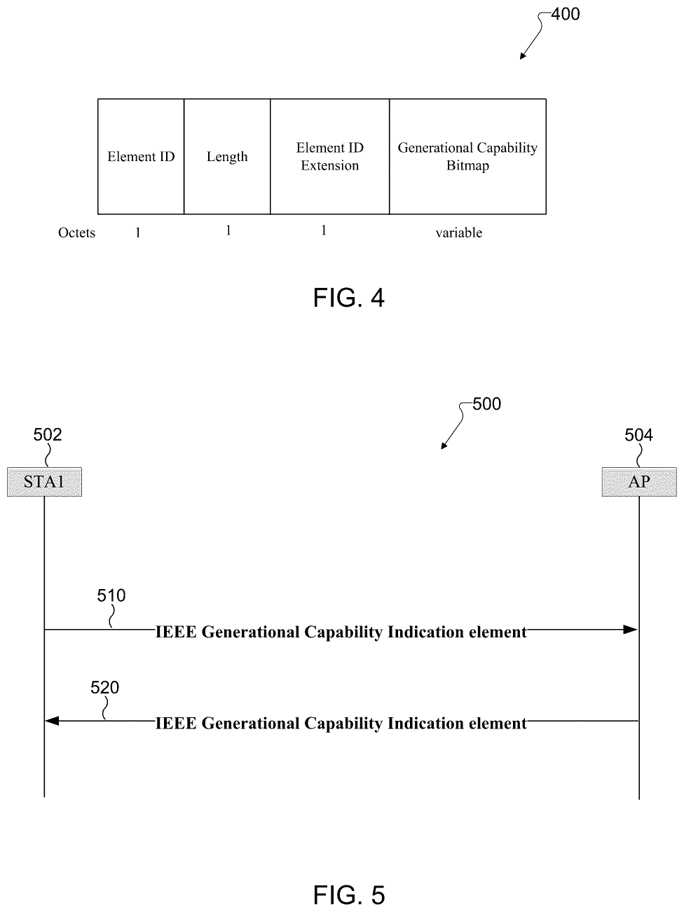

An example of a format for the IEEE generational capability indication element is shown in FIG. 4.

FIG. 4 illustrates an example of a generational capability indication element 400 according to embodiments of the present disclosure. The embodiment of a generational capability indication element of FIG. 4 is for illustration only. Different embodiments of a generational capability information element could be used without departing from the scope of this disclosure.

In the example of FIG. 4, the generational capability indication element 400 includes the following fields:
Element ID
Length
Element ID Extension
Generational Capability Bitmap

The length of the generational capability bitmap field can be derived from the length field of indication element 400. The length of the generational capability bitmap can be multiple of 8 bits.

Although FIG. 4 illustrates one example of a generational capability indication element 400, various changes may be made to FIG. 4. For example, various changes to the field lengths, the number of fields, etc. could be made according to particular needs.

In some embodiments, the generational capability bitmap field of indication element 400 may indicate which IEEE generations are supported by a STA that sends the indication element 400. For example, in some embodiments indication element 400 may include a generational capability bitmap, similar to as shown in Table 1. In these embodiments, indication element 400 may be referred to as an IEEE generational capability indication element.

TABLE 1
Generational Capability Bitmap Field in Generational Capability
Indication Element for IEEE wireless networking generations

| Bit | Meaning | Reference/Notes |
|---|---|---|
| 0 | IEEE 802.11n | Mandatory features of |
| | Supported | IEEE 802.11n |
| 1 | IEEE 802.11ac | Mandatory features of |
| | Supported | IEEE 802.11ac |
| 2 | IEEE 802.11ax | Mandatory features of |
| | Supported | IEEE 802.11ax |
| 3 | IEEE 802.11be | Mandatory features of |
| | Supported | IEEE 802.11be |
| 4 | IEEE 802.11bn | Mandatory features of |
| | Supported | IEEE 802.11bn |
| 5-last | Reserved | |

In some embodiments, support for other IEEE amendments can also be included in the generational capability bitmap field in indication element 400 such as IEEE 802.11bf, IEEE 802.11bk, IEEE 802.11bh, IEEE 802.11ah, IEEE 802.11ba, etc.

In some embodiments, a first STA that receives an IEEE generational capability indication element from a second STA may respond by sending another IEEE generational capability indication element to the first STA, indicating different IEEE generations supported by the second STA, similar as shown in FIG. 5.

FIG. 5 illustrates an example process 500 for IEEE generational capability indication element exchange according to embodiments of the present disclosure. An embodiment of the process illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a process for IEEE generational capability indication element exchange could be used without departing from the scope of this disclosure.

In the example of FIG. 5, process 500 begins at step 510. At step 510, a STA 502 (STA1) transmits, to an AP 504, a first IEEE generational capability indication element. The first IEEE generational capability indication element may indicate different IEEE generations supported by STA 502.

At step 520, in response to receiving the first IEEE generational capability indication element, AP 504 transmits, to STA 502, a second IEEE generational capability indication element. The second IEEE generational capability indication element may indicate different IEEE generations supported by AP 504.

Although FIG. 5 illustrates one example process 500 for IEEE generational capability indication element exchange, various changes may be made to FIG. 5. For example, while shown as a series of steps, various steps in FIG. 5 could overlap, occur in parallel, occur in a different order, occur any number of times, be omitted, or replaced by other steps.

In some embodiments, a first STA can include the IEEE generational capability indication element in a management frame and transmit the frame to a second STA, where the second STA can be an AP.

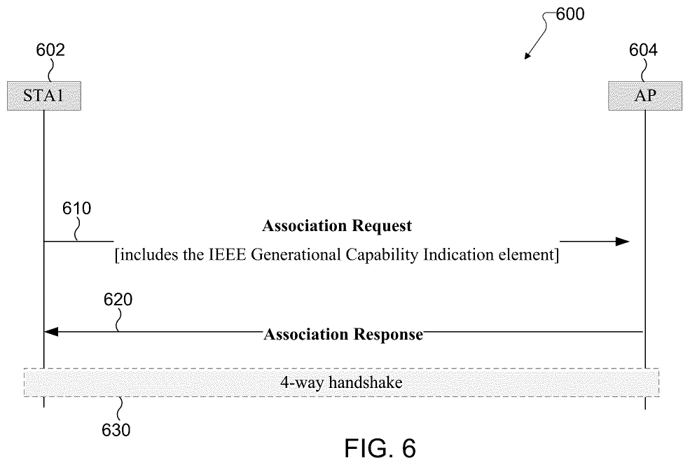

In some embodiments, the IEEE generational capability indication element can be shared with the AP during an association phase. For instance, the IEEE generational capability indication element can be included in any of the following frames:
Association Request frame (as shown in FIG. 6)
Reassociation Request frame
Association Response frame
Reassociation Response frame

FIG. 6 illustrates an example process 600 for sharing IEEE generational capability information during an association phase according to embodiments of the present disclosure. An embodiment of the process illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a process for sharing IEEE generational capability information during an association phase could be used without departing from the scope of this disclosure.

In the example of FIG. 6, process 600 begins at step 610. At step 610, a STA 602 (STA1) transmits, to an AP 604, an association request. The association request includes an IEEE generational capability indication element. The IEEE generational capability indication element may indicate different IEEE generations supported by STA 602.

At step 620, in response to receiving the association request, AP 604 transmits, to STA 602, an association response. In some embodiments, the association response may include an IEEE generational capability indication element that may indicate different IEEE generations supported by AP 604.

At step 630, STA 602 and AP 604 perform a 4-way handshake.

Although FIG. 6 illustrates one example process 600 for sharing IEEE generational capability information during an association phase, various changes may be made to FIG. 6. For example, while shown as a series of steps, various steps in FIG. 6 could overlap, occur in parallel, occur in a different order, occur any number of times, be omitted, or replaced by other steps.

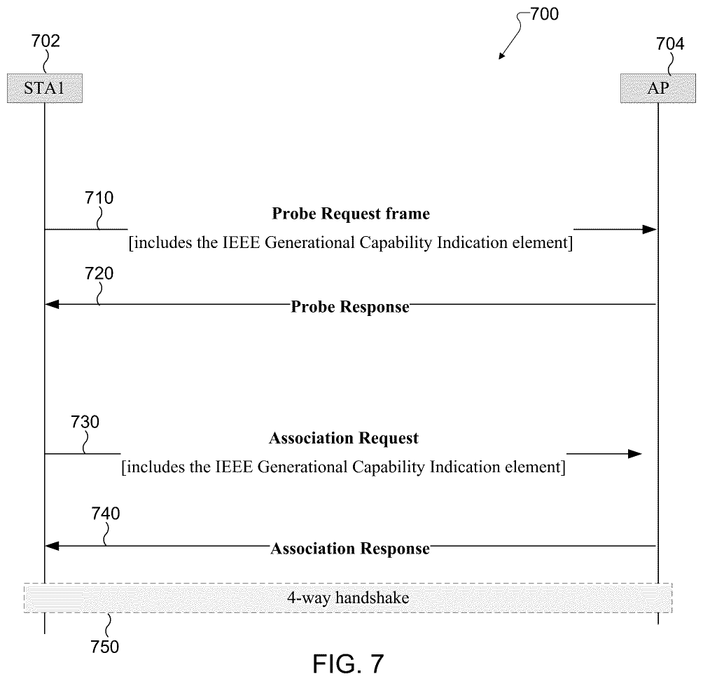

In some embodiments, a first STA can share its IEEE generational capability information either before or after the first STA associates with an AP. For instance, the IEEE generational capability indication element can be included in a probe request frame, similar as shown in FIG. 7.

FIG. 7 illustrates an example process 700 for sharing IEEE generational capability in a probe request frame according to embodiments of the present disclosure. An embodiment of the process illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a process for sharing IEEE generational capability information in a probe request frame could be used without departing from the scope of this disclosure.

In the example of FIG. 7, process 700 begins at step 710. At step 710, a STA 702 (STA1) transmits, to an AP 704, a probe request frame. The association request includes an IEEE generational capability indication element. The IEEE generational capability indication element may indicate different IEEE generations supported by STA 702.

At step 720 in response to receiving the probe request frame, AP 704 transmits, to STA 702, a probe response. In some embodiments, the probe response may include an IEEE generational capability indication element that may indicate different IEEE generations supported by AP 704.

At step 730, STA 702 transmits, to AP 704, an association request. The association request includes an IEEE generational capability indication element. The IEEE generational capability indication element may indicate different IEEE generations supported by STA 702.

At step 740, in response to receiving the association request, AP 704 transmits, to STA 702, an association response. In some embodiments, the association response may include an IEEE generational capability indication element that may indicate different IEEE generations supported by AP 704.

At step 750, STA 702 and AP 704 perform a 4-way handshake.

Although FIG. 7 illustrates one example process 700 for sharing IEEE generational capability information in a probe request frame, various changes may be made to FIG. 7. For example, while shown as a series of steps, various steps in FIG. 7 could overlap, occur in parallel, occur in a different order, occur any number of times, be omitted, or replaced by other steps.

Generational capability can be very much related to the privacy of a STA. Therefore, secure transmission of any kind of generational capability is desirable. A new protected management frame can be defined that can carry the IEEE generational capability indication element. In some embodiments, an IEEE generational capability frame can be a protected management frame (PMF) that can include the generational capability of a STA and can include an IEEE generational capability indication element. For example, if the IEEE generational capability indication element is included in a management frame, then the protected frame subfield of the frame control field of the management frame can be set to 1. In some embodiments, the IEEE generational capability frame can be a robust management frame and can be protected by the management frame protection service.

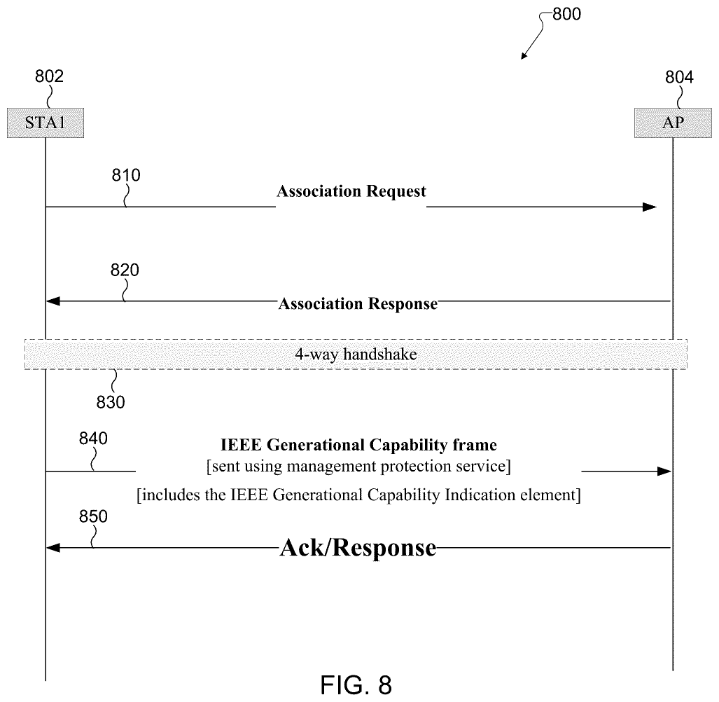

In some embodiments, a first STA can send its generational capability related information to a second STA by including the corresponding element, (e.g., an IEEE generational capability indication element), in a PMF, similar as shown in FIG. 8.

FIG. 8 illustrates an example process 800 for sending IEEE generational capability information using a protected management frame according to embodiments of the present disclosure. An embodiment of the process illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a process for sending IEEE generational capability information using a protected management frame could be used without departing from the scope of this disclosure.

In the example of FIG. 8, process 800 begins at step 810. At step 810, a STA 802 (STA1) transmits, to an AP 804, an association request.

At step 820, in response to receiving the association request, AP 804 transmits, to STA 802, an association response.

At step 830, STA 802 and AP 804 perform a 4-way handshake.

At step 840, STA 802 transmits, to AP 804, an IEEE generational capability frame using management protection service. The IEEE generational capability frame includes an IEEE generational capability indication element. The IEEE generational capability indication element may indicate different IEEE generations supported by STA 802.

Although FIG. 8 illustrates one example process 800 for sending IEEE generational capability information using a protected management frame, various changes may be made to FIG. 8. For example, while shown as a series of steps, various steps in FIG. 8 could overlap, occur in parallel, occur in a different order, occur any number of times, be omitted, or replaced by other steps.

In some embodiments, a first STA can indicate its support of different generations of WFA wireless networking standards to a second STA, where the first STA can be either an AP or a non-AP STA, and the second STA can also be either an AP or a non-AP STA.

In some embodiments, if a first STA intends to indicate the first STA's WFA generational support to a second STA, then the first STA can send a WFA generational capability indication attribute to the second STA, where the WFA generational capability indication attribute can be included in a Wi-Fi Alliance Capabilities element. In this element, the first STA can indicate the first STA's generational capabilities such as whether the first STA supports Wi-Fi 4, Wi-Fi 5, Wi-Fi 6, Wi-Fi 7, Wi-Fi 8 etc.

An example of a format for the WFA generational capability indication element is shown in FIG. 4.

In some embodiments, the generational capability bitmap field of indication element 400 may indicate which WFA generations are supported by the STA that sends the indication element 400. For example, in some embodiments indication element 400 may include a generational capability bitmap, similar to as shown in Table 2. In these embodiments, indication element 400 may be referred to as a WFA generational capability indication element.

TABLE 2
Generational Capability Bitmap Field in Generational Capability
Indication Element for WFA wireless networking generations

| Bit | Meaning | Reference/Notes |
|---|---|---|
| 0 | Wi-Fi 4 Supported | Mandatory features of |
| | | Wi-Fi 4 |
| 1 | Wi-Fi 5 Supported | Mandatory features of |
| | | Wi-Fi 5 |
| 2 | Wi-Fi 6 Supported | Mandatory features of |
| | | Wi-Fi 6 |
| 3 | Wi-Fi 7 Supported | Mandatory features of |
| | | Wi-Fi 7 |
| 4 | Wi-Fi 8 Supported | Mandatory features of |
| | | Wi-Fi 8 |
| 5-last | Reserved | |

In some embodiments, support for other WFA amendments can also be included in the generational capability bitmap field in indication element 400 such as Wi-Fi Direct, Wi-Fi Aware, Wi-Fi Miracast, Wi-Fi QoS Management, etc.

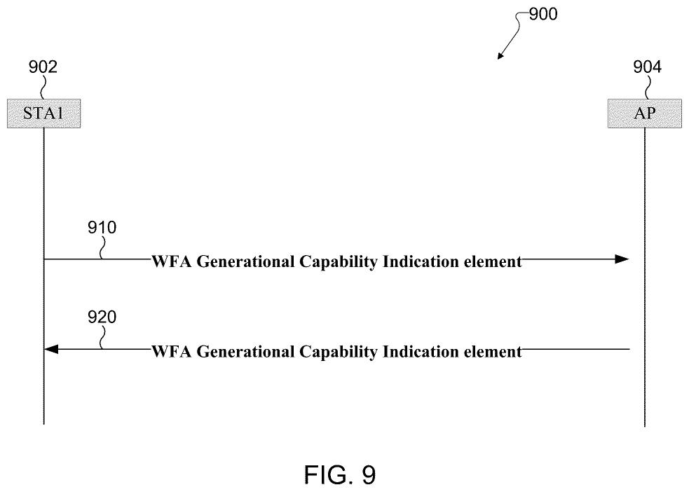

In some embodiments, a first STA that receives a WFA generational capability indication element from a second STA may respond by sending another WFA generational capability indication element to the first STA, indicating different WFA generations supported by the second STA, similar as shown in FIG. 9.

FIG. 9 illustrates an example process 900 for WFA generational capability indication element exchange according to embodiments of the present disclosure. An embodiment of the process illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a process for WFA generational capability indication element exchange could be used without departing from the scope of this disclosure.

In the example of FIG. 9, process 900 begins at step 910. At step 910, a STA 902 (STA1) transmits, to an AP 904, a first WFA generational capability indication element. The first IEEE generational capability indication element may indicate different WFA generations supported by STA 902.

At step 920, in response to receiving the first WFA generational capability indication element, AP 904 transmits, to STA 902, a second WFA generational capability indication element. The second WFA generational capability indication element may indicate different WFA generations supported by AP 904.

Although FIG. 9 illustrates one example process 900 for WFA generational capability indication element exchange, various changes may be made to FIG. 9. For example, while shown as a series of steps, various steps in FIG. 9 could overlap, occur in parallel, occur in a different order, occur any number of times, be omitted, or replaced by other steps.

In some embodiments, a first STA can include the WFA generational capability indication element in a management frame and transmit the frame to a second STA, where the second STA can be an AP.

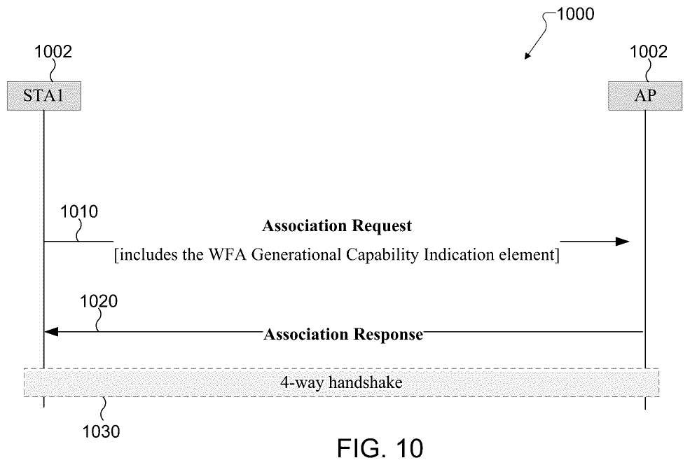

In some embodiments, the WFA generational capability indication element can be shared with the AP during an association phase. For instance, the WFA generational capability indication element can be included in any of the following frames:
Association Request frame (as shown in FIG. 10)
Reassociation Request frame
Association Response frame
Reassociation Response frame

FIG. 10 illustrates an example process 1000 for sharing WFA generational capability information during an association phase according to embodiments of the present disclosure. An embodiment of the process illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a process for sharing WFA generational capability information during an association phase could be used without departing from the scope of this disclosure.

In the example of FIG. 10, process 1000 begins at step 1010. At step 1010, a STA 1002 (STA1) transmits, to an AP 1004, an association request. The association request includes a WFA generational capability indication element. The WFA generational capability indication element may indicate different WFA generations supported by STA 1002.

At step 1020, in response to receiving the association request, AP 1004 transmits, to STA 1002, an association response. In some embodiments, the association response may include a WFA generational capability indication element that may indicate different WFA generations supported by AP 1004.

At step 1030, STA 1002 and AP 1004 perform a 4-way handshake.

Although FIG. 10 illustrates one example process 1000 for sharing WFA generational capability information during an association phase, various changes may be made to FIG. 10. For example, while shown as a series of steps, various steps in FIG. 10 could overlap, occur in parallel, occur in a different order, occur any number of times, be omitted, or replaced by other steps.

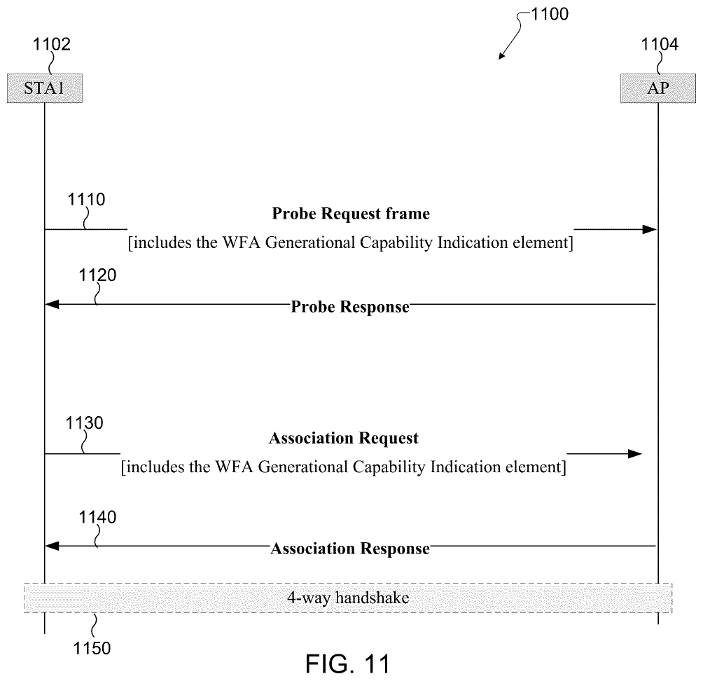

In some embodiments, a first STA can share its WFA generational capability information either before or after the first STA associates with an AP. For instance, the WFA generational capability indication element can be included in a probe request frame, similar as shown in FIG. 11.

FIG. 11 illustrates an example process 1100 for sharing WFA generational capability in a probe request frame according to embodiments of the present disclosure. An embodiment of the process illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a process for sharing WFA generational capability information in a probe request frame could be used without departing from the scope of this disclosure.

In the example of FIG. 11, process 1100 begins at step 1110. At step 1110, a STA 1102 (STA1) transmits, to an AP 1104, a probe request frame. The association request includes a WFA generational capability indication element. The WFA generational capability indication element may indicate different WFA generations supported by STA 1102.

At step 1120 in response to receiving the probe request frame, AP 1104 transmits, to STA 1102, a probe response. In some embodiments, the probe response may include a WFA generational capability indication element that may indicate different WFA generations supported by AP 1104.

At step 1130, STA 1102 transmits, to AP 1104, an association request. The association request includes a WFA generational capability indication element. The WFA generational capability indication element may indicate different WFA generations supported by STA 1102.

At step 1140, in response to receiving the association request, AP 1104 transmits, to STA 1102, an association response. In some embodiments, the association response may include a WFA generational capability indication element that may indicate different WFA generations supported by AP 1104.

At step 1150, STA 1102 and AP 1104 perform a 4-way handshake.

Although FIG. 11 illustrates one example process 1100 for sharing WFA generational capability information in a probe request frame, various changes may be made to FIG. 11. For example, while shown as a series of steps, various steps in FIG. 11 could overlap, occur in parallel, occur in a different order, occur any number of times, be omitted, or replaced by other steps.

As previously noted, generational capability can be very much related to the privacy of a STA. A new protected management frame can be defined that can carry the WFA generational capability indication element. In some embodiments, a WFA generational capability frame can be a PMF that can include the generational capability of a STA and can include a WFA generational capability indication element. For example, if the WFA generational capability indication element is included in a management frame, then the protected frame subfield of the frame control field of the management frame can be set to 1. In some embodiments, the WFA generational capability frame can be a robust management frame and can be protected by the management frame protection service.

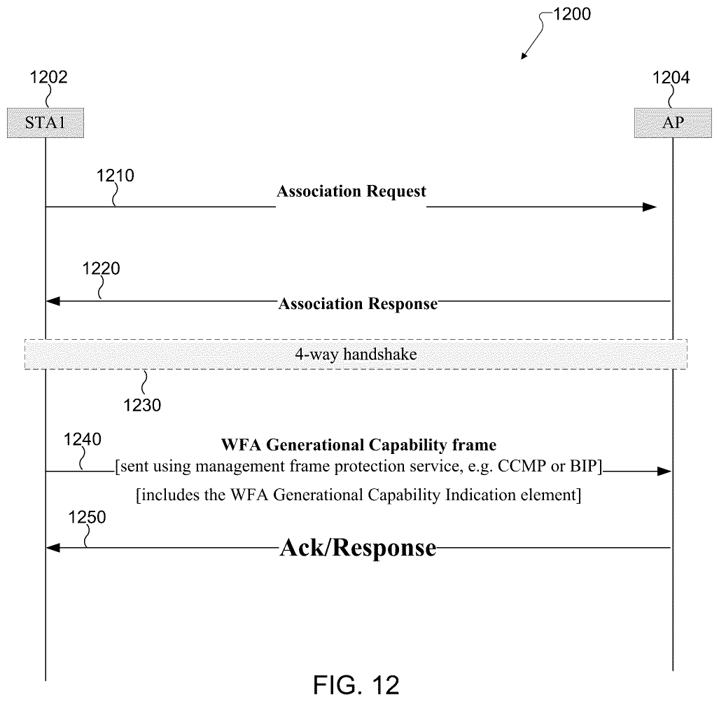

In some embodiments, a first STA can send its generational capability related information to a second STA by including the corresponding element, (e.g., a WFA generational capability indication element), in a PMF, similar as shown in FIG. 12.

FIG. 12 illustrates an example process 1200 for sending WFA generational capability information using a protected management frame according to embodiments of the present disclosure. An embodiment of the process illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a process for sending WFA generational capability information using a protected management frame could be used without departing from the scope of this disclosure.

In the example of FIG. 12, process 1200 begins at step 1210. At step 1210, a STA 1202 (STA1) transmits, to an AP 1204, an association request.

At step 1220, in response to receiving the association request, AP 1204 transmits, to STA 1202, an association response.

At step 1230, STA 802 and AP 1204 perform a 4-way handshake.

At step 1240, STA 1202 transmits, to AP 1204, a WFA generational capability frame using management protection service. The WFA generational capability frame includes a WFA generational capability indication element. The WFA generational capability indication element may indicate different WFA generations supported by STA 1202.

Although FIG. 12 illustrates one example process 1200 for sending WFA generational capability information using a protected management frame, various changes may be made to FIG. 12. For example, while shown as a series of steps, various steps in FIG. 12 could overlap, occur in parallel, occur in a different order, occur any number of times, be omitted, or replaced by other steps.

In some embodiments a first STA can indicate whether the first STA is certified for different versions of Wi-Fi Alliance (WFA) generations to a second STA, where the first STA can be either an AP or a non-AP STA, and the second STA can also be either an AP or a non-AP STA.

In some embodiments, if a first STA intends to indicate its WFA generational certification status to a second STA, then the first STA can send a WFA generational capability indication attribute to the second STA, where the WFA generational capability indication attribute can be included in a Wi-Fi Alliance Capabilities element. In this element, the first STA can indicate the first STAs generational certification such as whether the first STA is Wi-Fi 4 certified, Wi-Fi 5 certified, Wi-Fi 6 certified, Wi-Fi 7 certified, Wi-Fi 8 certified etc.

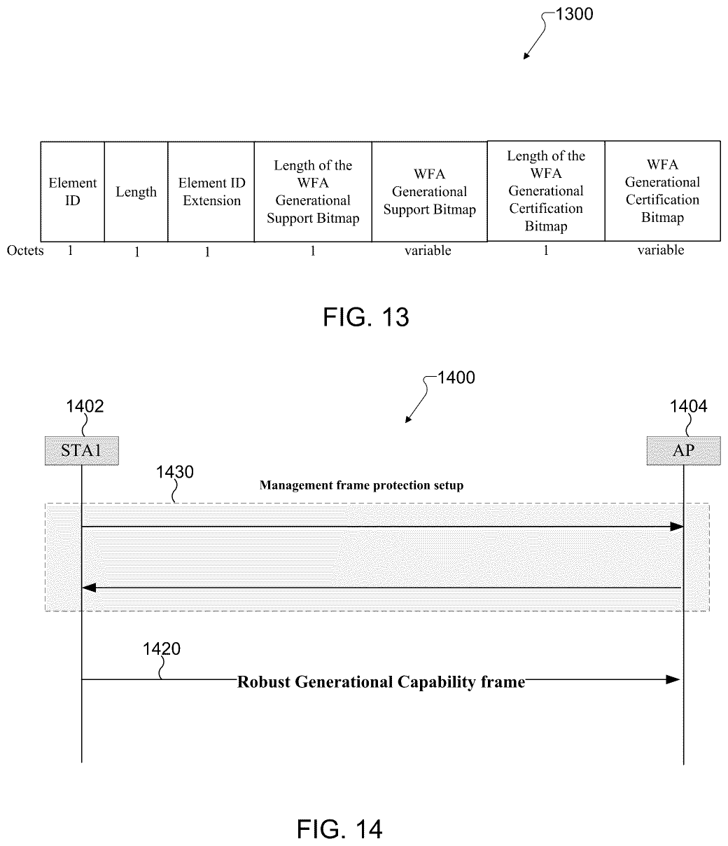

An example of a format for a WFA generational capability indication element that also includes Wi-Fi Alliance generational certification is shown in FIG. 13.

FIG. 13 illustrates an example of a generational capability indication element 1300 that also includes Wi-Fi Alliance generational certification according to embodiments of the present disclosure. The embodiment of a generational capability indication element of FIG. 13 is for illustration only. Different embodiments of a generational capability information element that also includes Wi-Fi Alliance generational certification could be used without departing from the scope of this disclosure.

In the example of FIG. 13, the generational capability indication element 1300 includes the following fields:
Element ID
Length
Element ID Extension
Length of the WFA Generational Support Bitmap
WFA Generational Capability Bitmap
Length of the WFA Generational Certification Bitmap
WFA Generational Certification Bitmap

In FIG. 13, the length field indicates the length of indication element 1300.

In FIG. 13, the length of the WFA generational support bitmap field indicates the length of the WFA Generational Support Bitmap field.

In FIG. 13 the length of the WFA generational certification bitmap field indicates the length of the WFA generational certification bitmap field.

Although FIG. 13 illustrates one example 1300 of a generational capability indication element that also includes Wi-Fi Alliance generational certification, various changes may be made to FIG. 13. For example, various changes to the field lengths, the number of fields, etc. could be made according to particular needs.

In indication element 1300, the WFA Generational Support Bitmap is a bitmap where each bit can indicate whether or not the STA is certified for the corresponding WFA Wi-Fi generation. In some embodiments, indication element 1300 may include a WFA generational capability bitmap, similar as shown in Table 3.

TABLE 3
WFA Generational Certification Bitmap Field in
WFA Generational Capability Indication Element
for WFA Wireless Networking Certifications

| Bit | Meaning | Reference |
|---|---|---|
| 0 | Wi-Fi 4 CERTIFIED | Mandatory features of |
| | | Wi-Fi 4 |
| 1 | Wi-Fi 5 CERTIFIED | Mandatory features of |
| | | Wi-Fi 5 |
| 2 | Wi-Fi 6 CERTIFIED | Mandatory features of |
| | | Wi-Fi 6 |
| 3 | Wi-Fi 7 CERTIFIED | Mandatory features of |
| | | Wi-Fi 7 |
| 4 | Wi-Fi 8 CERTIFIED | Mandatory features of |
| | | Wi-Fi 8 |
| 5-last | Reserved | |

In some embodiments, a WFA generational capability indication element as described in this embodiment can be a Wi-Fi Alliance capabilities attribute, where this Wi-Fi Alliance capabilities attribute can be included in the Wi-Fi Alliance capabilities element. In some embodiments, the Wi-Fi Alliance capabilities element can be a vendor specific element.

In some embodiments, a generational capability frame can be a robust management frame or a robust action frame. If the generational capability frame is a robust action frame, then the generational capability frame can have a corresponding category value for the action field. For example, category value 240 can be used for a robust generational capability frame, similar as shown in Table 4.

TABLE 4
Generational Capability Frame as a Robust Action Frame

| | | | Group Addressed |
|---|---|---|---|
| Code | Meaning | Robust | Privacy |
| . | . | . | . |
| . | . | . | . |
| . | . | . | . |
| 240 | Robust Generational | Yes | Yes |
| | Capability | | |
| . | . | . | . |
| . | . | . | . |
| . | . | . | . |

In some embodiments, the frame body of a robust generational capability frame, which can be a protected management frame, may contain the information shown in Table 5.

TABLE 5
Example Robust Generational Capability Frame

| Order | Information |
|---|---|
| 1 | Reason Code |
| Last-3 | WFA Generational Capability Indication element |
| Last-2 | IEEE Generational Capability Indication element |
| Last-1 | One or more Vendor Specific element |
| Last | The MME is present when management frame protection is |
| | enabled at the STA transmitting the frame and the frame is a |
| | group addressed frame |

In Table 5, the format of the IEEE generational capability indication element can be similar to the WFA generational capability indication element as shown in Table 2, except that instead of indicating support for different WFA generations, this IEEE generational capability indication element can indicate support for different IEEE generations such as IEEE 802.11ah, IEEE 802.11n, IEEE 802.11ac, IEEE 802.11ax, IEEE 802.11be, etc. (e.g., as shown in Table 1).

In some embodiments, if a vendor specific element is included in the robust generational capability indication frame, the vendor specific element may contain a WFA generational capability indication element.

In some embodiments, before sending a robust generational capability frame to an AP, a STA can set up or negotiate management frame protection with the AP, similar as shown in FIG. 14.

FIG. 14 illustrates an example process 1400 for setting up management frame protection before sending a robust generational capability frame according to embodiments of the present disclosure. An embodiment of the process illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a process for setting up management frame protection before sending a robust generational capability frame could be used without departing from the scope of this disclosure.

In the example of FIG. 14, process 1400 begins at step 1410. At step 1410, a STA 1402 (STA1) and an AP 1404 perform management frame protection setup.

At step 1420, STA 1402 transmits, to AP 1404, a robust generational capability frame.

Although FIG. 14 illustrates one example process 1400 for setting up management frame protection before sending a robust generational capability frame, various changes may be made to FIG. 14. For example, while shown as a series of steps, various steps in FIG. 14 could overlap, occur in parallel, occur in a different order, occur any number of times, be omitted, or replaced by other steps.

In some embodiments, a first STA can send a request to a second STA soliciting generational capability information from the second STA. For example, an AP can send a vendor specific request frame or a vendor specific request element to a STA to solicit the STA's generational capability support information.

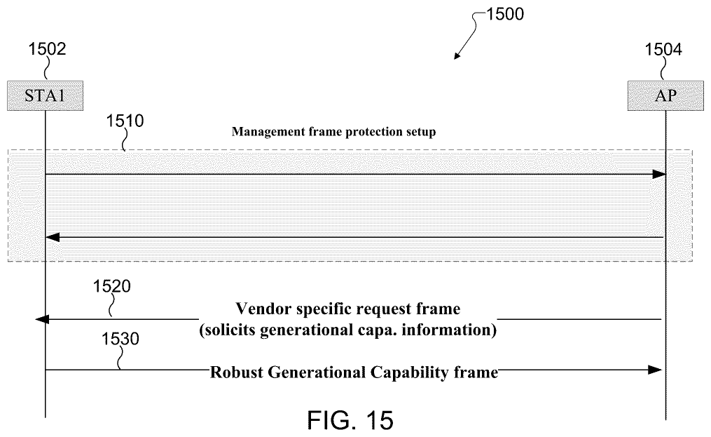

In some embodiments, upon receiving a request from an AP to share generational capability information, a STA can perform management frame protection setup procedure with the AP. After performing the management frame protection set procedure, the STA can send a robust or protected management frame to the AP, where the robust or protected management frame may contain an IEEE generational capability indication element or a WFA generational capability indication element, similar as shown in FIG. 15.

FIG. 15 illustrates an example process 1500 for soliciting generational capability information from a STA. An embodiment of the process illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a process for soliciting generational capability information from a STA could be used without departing from the scope of this disclosure.

In the example of FIG. 5, process 1500 begins at step 1510. At step 1510, a STA 1502 (STA1) and an AP 1504 perform management frame protection setup.

At step 1520, AP 1504 transmits, to STA 1502, a vendor specific request frame that solicits generational capability information from STA 1502.

At step 1530, STA 1502 transmits, to AP 1504, a robust generational capability frame.

Although FIG. 15 illustrates one example process 1500 for soliciting generational capability information from a STA, various changes may be made to FIG. 15. For example, while shown as a series of steps, various steps in FIG. 15 could overlap, occur in parallel, occur in a different order, occur any number of times, be omitted, or replaced by other steps.

As noted above, various embodiments of the present disclosure provide mechanisms to set up dynamic SCS between an AP and a non-AP STA or between any two STAs (AP or non-AP STAs).

In some embodiments, a first STA can request to set up a new mode of SCS with a second STA, where the second STA can be an AP with which the first STA is associated. As described herein, this mode of SCS may be referred to as dynamic SCS.

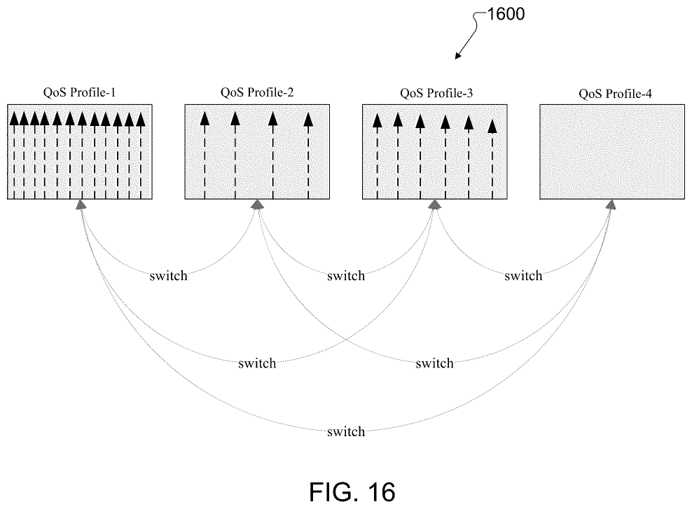

In some embodiments, dynamic SCS may include more than one QoS profile, and a first STA that has set up dynamic SCS with its associated AP may request to dynamically switch between these QoS profiles, similar as shown in FIG. 16.

FIG. 16 illustrates an example 1600 of dynamic switching among different QoS profiles within dynamic SCS according to embodiments of the present disclosure. The embodiment of dynamic switching among different QoS profiles within dynamic SCS of FIG. 16 is for illustration only. Different embodiments of dynamic switching among different QoS profiles within dynamic SCS could be used without departing from the scope of this disclosure.

In the example of FIG. 16, a first STA has set up dynamic SCS with its associated AP including four QoS profiles. The first STA may dynamically switch between any of the four QoS profiles shown in FIG. 16 to a different one of the four QoS profiles (e.g., from QoS profile-1 to QoS profile-3, etc.).

Although FIG. 16 illustrates one example 1600 of dynamic switching among different QoS profiles within dynamic SCS, various changes may be made to FIG. 16. For example, various changes to number of QoS profiles could be made, etc. according to particular needs.

In some embodiments, a particular dynamic SCS negotiation can be identified by a Dynamic SCS ID or D-SCS ID. Within a particular dynamic SCS setup identified by a D-SCS ID, a QoS profile can be identified by a QoS Profile ID. A particular dynamic SCS setup may contain one or more QoS profiles, each having different a QoS Profile ID.

In some embodiments a first STA can request to set up dynamic SCS with its associated AP. For example, in some embodiments, in order to set up a dynamic SCS, a first STA can send an SCS request frame to the first STA's associated AP. The SCS request frame may contain information about different QoS profiles that the first STA intends to switch between. Upon receiving an SCS request frame from an associated STA, the AP, in response, can send an SCS Response frame to the STA. The SCS response frame may indicate whether the AP has accepted, rejected, or suggested an alternative set of SCS parameters or QoS profile parameters.

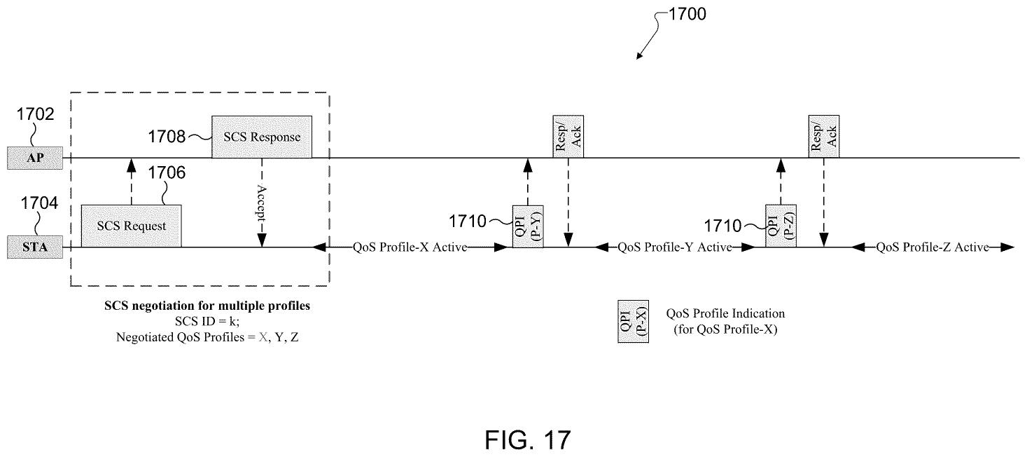

In some embodiments, for the scenario where a first STA has sent an SCS request frame to the first STA's associated AP for setting up a dynamic SCS that corresponds to a first set of QoS profiles, if the AP has accepted the request, then after the initial dynamic SCS setup is established, the first STA can send a QoS profile indication frame to the AP indicating the QoS profile that the first STA intends to activate, where the indicated QoS profile is within the first set of QoS profiles that correspond to the dynamic SCS negotiated between the first STA and the AP, similar as shown in FIG. 17.

FIG. 17 illustrates an example 1700 of using SCS request/response for setting up dynamic SCS according to embodiments of the present disclosure. The embodiment of setting up dynamic SCS of FIG. 17 is for illustration only. Different embodiments of using SCS request/response for setting up dynamic SCS could be used without departing from the scope of this disclosure.

In the example of FIG. 17, a STA 1704 has sent an SCS request frame 1706 to STA 1704's associated AP 1702 for setting up a dynamic SCS that corresponds to a first set of QoS profiles (X, Y, and Z). AP 1702 has accepted the request by sending an SCS response frame 1708. After the initial dynamic SCS setup is established, while QoS profile-X is active, the STA 1704 sends a QoS profile indication frame 1710 to the AP 1702 indicating that STA 1704 intends to activate QoS profile-Y. Later, while QoS profile-Y is active, STA 1704 sends a QoS profile indication frame 1712 to the AP 1702 indicating that STA 1704 intends to activate QoS profile Z.

Although FIG. 17 illustrates one example 1700 of using SCS request/response for setting up dynamic SCS, various changes may be made to FIG. 17. For example, various changes to the SCS negotiation could be made, etc. according to particular needs.

In some embodiments, the QoS Profile Indication (QPI) frame can be a control frame that can indicate the Profile ID that the first STA intends to switch to. In some embodiments the QPI frame may also include the SCS ID that corresponds to the QoS profile.

In some embodiments, in order to set up dynamic SCS, a first STA can send a Dynamic SCS (D-SCS) request frame to its associated AP. The D-SCS request frame may contain information about different QoS profiles that the first STA intends to switch between. Upon receiving a D-SCS request frame from an associated STA, the AP, in response, can send a D-SCS response frame to the STA. The D-SCS response frame may indicate whether the AP has accepted, rejected, or suggested an alternative set of D-SCS parameters or QoS profile parameters.

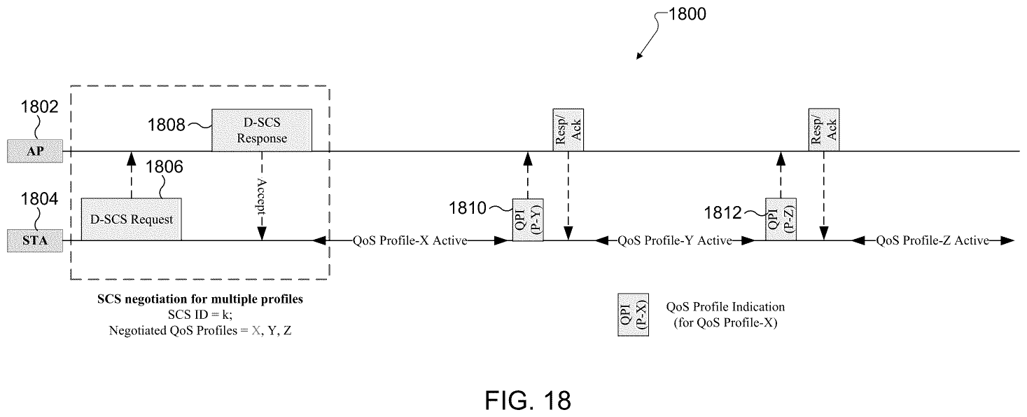

In some embodiments, for the scenario where a first STA has sent a D-SCS request frame to its associated AP for setting up a dynamic SCS that corresponds to a first set of QoS profiles, if the AP has accepted the request, then after the initial dynamic SCS setup is established, the first STA can send a QoS profile indication frame to the AP indicating the QoS profile that the first STA intends to activate, where the indicated QoS profile is within the first set of QoS profiles that correspond to the dynamic SCS negotiated between the first STA and the AP, similar as shown in FIG. 18.

FIG. 18 illustrates an example 1800 of using D-SCS request/response for setting up dynamic SCS according to embodiments of the present disclosure. The embodiment of setting up dynamic SCS of FIG. 18 is for illustration only. Different embodiments of using D-SCS request/response for setting up dynamic SCS could be used without departing from the scope of this disclosure.

In the example of FIG. 18, a STA 1804 has sent a D-SCS request frame 1806 to STA 1804's associated AP 1802 for setting up a dynamic SCS that corresponds to a first set of QoS profiles (X, Y, and Z). AP 1802 has accepted the request by sending a D-SCS response frame 1808. After the initial dynamic SCS setup is established, while QoS profile-X is active, the STA 1804 sends a QoS profile indication frame 1810 to the AP 1802 indicating that STA 1804 intends to activate QoS profile-Y. Later, while QoS profile-Y is active, STA 1804 sends a QoS profile indication frame 1812 to the AP 1802 indicating that STA 1804 intends to activate QoS profile Z.

Although FIG. 18 illustrates one example 1800 of using D-SCS request/response for setting up dynamic SCS, various changes may be made to FIG. 18. For example, various changes to the SCS negotiation could be made, etc. according to particular needs.

In some embodiments, for the scenario where a first STA intends to set up a dynamic SCS with its associated AP and sends a D-SCS request frame, the D-SCS request frame may indicate different D-SCS ID or SCS ID among which the first STA intends to dynamically switch.

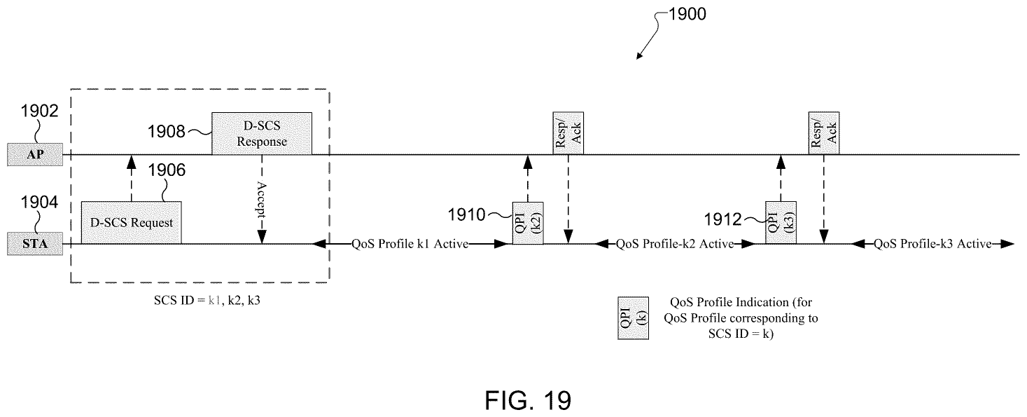

In some embodiments, for the scenario where a first STA has sent a D-SCS Request frame to its associated AP for setting up a dynamic SCS that corresponds to a first set of QoS profiles each characterized by a separate SCS ID or D-SCS ID, if the AP has accepted the request, then after the initial dynamic SCS setup is established, the first STA can send a QoS profile indication frame to the AP indicating the D-SCS ID or SCS ID that the first STA intends to activate, where the indicated SCS ID or D-SCS ID is within the first set of QoS profiles that correspond to the dynamic SCS negotiated between the first STA and the AP, similar as shown in FIG. 19.

FIG. 19 illustrates an example 1900 of dynamic profile change based on SCS ID according to embodiments of the present disclosure. The embodiment of dynamic profile change of FIG. 19 is for illustration only. Different embodiments of dynamic profile change based on SCS ID could be used without departing from the scope of this disclosure.

In the example of FIG. 19, a STA 1904 has sent a D-SCS request frame 1906 to STA 1904's associated AP 1902 for setting up a dynamic SCS that corresponds to a first set of SCS IDs (k1, k2, and k3). AP 1902 has accepted the request by sending a D-SCS response frame 1908. After the initial dynamic SCS setup is established, while QoS profile k1 is active, the STA 1904 sends a QoS profile indication frame 1910 to the AP 1902 indicating that STA 1904 intends to activate SCS ID k2. Later, while QoS profile-k2 is active, STA 1904 sends a QoS profile indication frame 1912 to the AP 1902 indicating that STA 1804 intends to activate SCS ID k3.

Although FIG. 19 illustrates one example 1900 of dynamic profile change based on SCS ID, various changes may be made to FIG. 19. For example, various changes to the SCS negotiation could be made, etc. according to particular needs.

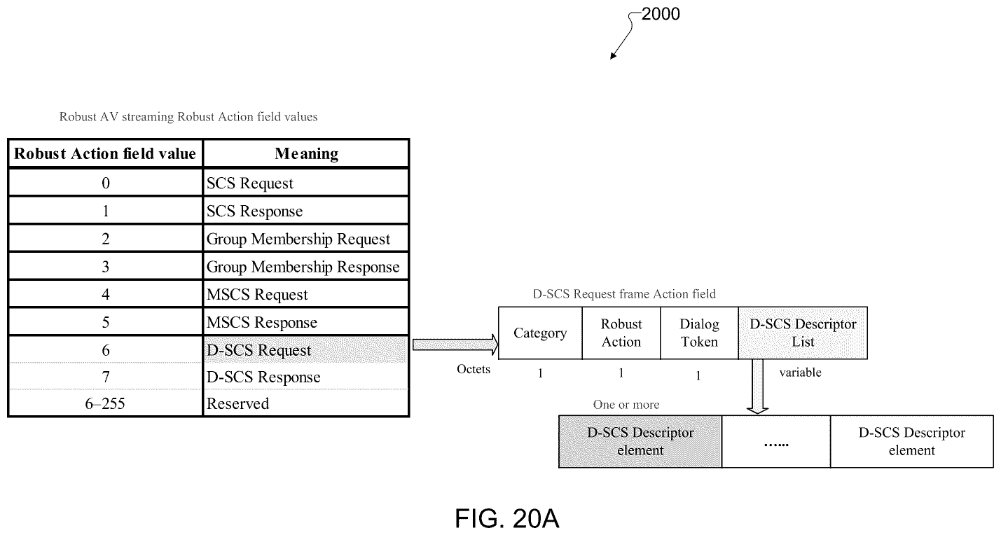

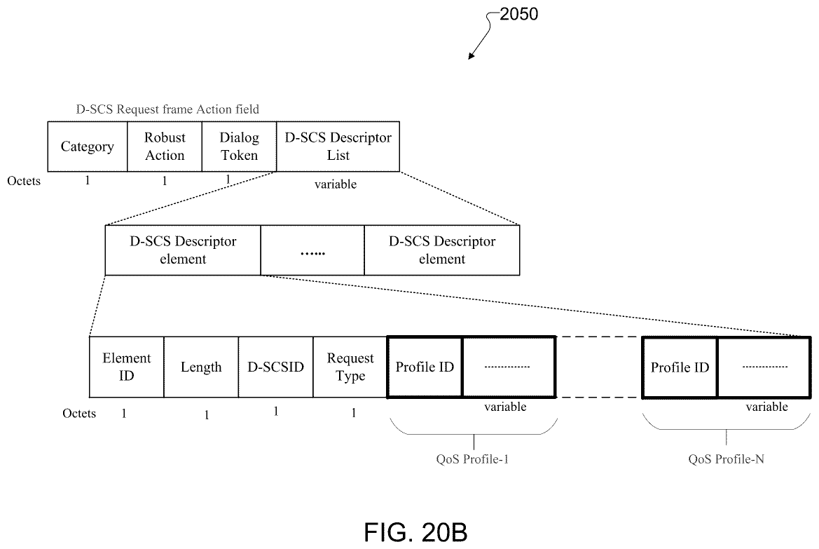

In some embodiments, in order to request to set up dynamic SCS to switch among different profiles within the SCS, a first STA can send a Dynamic SCS (D-SCS) request frame to a second STA, where the second STA can be an AP with which the first STA is associated. An example format of the D-SCS Request frame is shown in FIGS. 20A and 20B.

FIGS. 20A and 20B illustrate examples 2000 and 2050 of a format for a D-SCS request frame according to embodiments of the present disclosure. The embodiments of a D-SCS request frame of FIGS. 20A and 20B are for illustration only. Different embodiments of a format for a D-SCS request frame could be used without departing from the scope of this disclosure.

In the example of FIG. 20A, the D-SCS request frame includes the following elements:
Category
Robust Action
Dialog Token
D-SCS Descriptor List

In some embodiments, the D-SCS descriptor list in the D-SCS request frame can contain one or more D-SCS Descriptor elements, similar as shown in FIGS. 20A and 20B.

In some embodiments a D-SCS descriptor element may carry one or more QoS Profiles among which the STA sending the element wants to dynamically switch, similar as shown in FIG. 20B.

In FIG. 20B, the D-SCS ID field within the D-SCS descriptor element indicates the ID of the dynamic SCS negotiation.

In FIG. 20B, the Profile ID field may indicate a QoS profile ID within the D-SCS identified by the D-SCS ID.

In FIG. 20B, the Request Type field may indicate Add, Remove, or Change D-SCS setup.

Although FIGS. 20A and 20B illustrate examples 2000 and 2050 of a format for a D-SCS request frame, various changes may be made to FIGS. 20A and 20B. For example, various changes to the fields could be made, etc. according to particular needs.

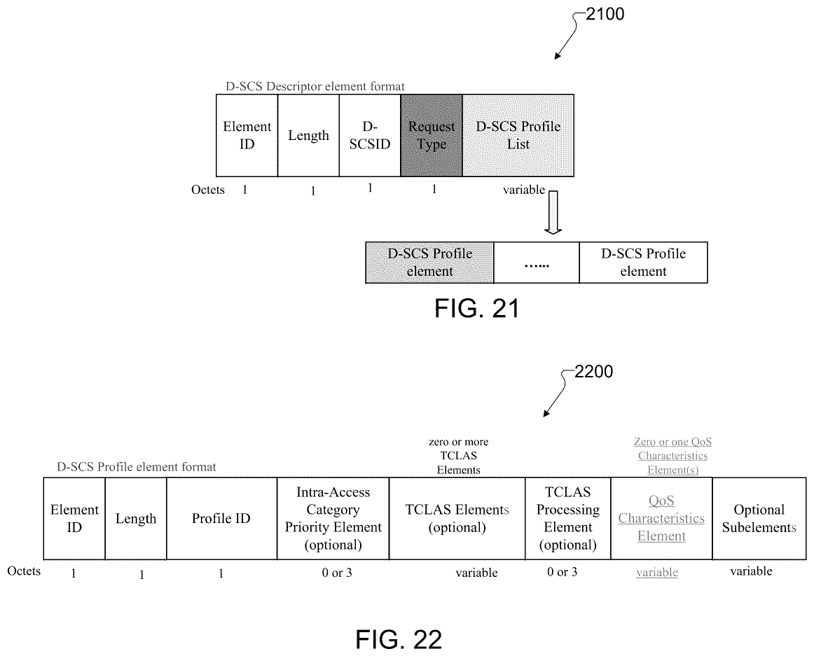

In some embodiments, the format of the D-SCS Descriptor element may be similar as shown in FIG. 21.

FIG. 21 illustrates an example 2100 of a format for a D-SCS descriptor element according to embodiments of the present disclosure. The embodiment of a D-SCS descriptor element of FIG. 21 is for illustration only. Different embodiments of a format for a D-SCS descriptor element could be used without departing from the scope of this disclosure.

In the example of FIG. 21, the D-SCS descriptor element includes the following fields:
Element ID
Length
D-SCSID
Request Type
D-SCS Profile List

In some embodiments, the D-SCS Profile List may contain one or more D-SCS Profile elements, similar as shown in FIG. 21.

Although FIG. 21 illustrates one example 2100 of a format for a D-SCS descriptor element, various changes may be made to FIG. 21. For example, various changes to the fields could be made, etc. according to particular needs.

In some embodiments, the format of the D-SCS profile element may have flexible traffic classification (TCLAS), similar as shown in FIG. 22.

FIG. 22 illustrates an example 2200 of a format for a D-SCS profile element according to embodiments of the present disclosure. The embodiment of a D-SCS profile element of FIG. 22 is for illustration only. Different embodiments of a format for a D-SCS profile element could be used without departing from the scope of this disclosure.

In the example of FIG. 22, the D-SCS profile element includes the following fields:
Element ID
Length
Profile ID
Intra-Access Category Priority Element (optional)
TCLAS Elements (optional)
QoS Characteristics Element
Optional Sub-elements

In the example of FIG. 22, the Profile ID field may indicate a QoS profile ID within the D-SCS identified by the D-SCS ID.

Although FIG. 22 illustrates one example 2200 of a format for a D-SCS profile element, various changes may be made to FIG. 22. For example, various changes to the fields could be made, etc. according to particular needs.

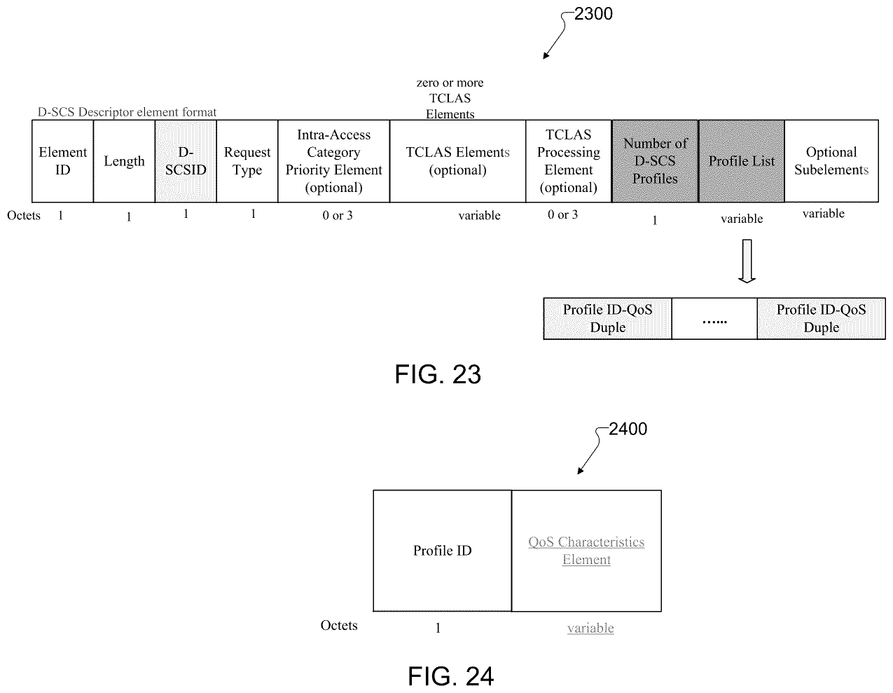

In some embodiments, the format of the D-SCS descriptor element may have fixed TCLAS, similar as shown in FIG. 23.

FIG. 23 illustrates another example 2300 of a format for a D-SCS descriptor element according to embodiments of the present disclosure. The embodiment of a D-SCS profile element of FIG. 23 is for illustration only. Different embodiments of a format for a D-SCS profile element could be used without departing from the scope of this disclosure.

In the example of FIG. 23, the D-SCS profile element includes the following fields:
Element ID
Length
Profile ID
D-SCSID
Request Type
Intra-Access Category Priority Element (optional)
TCLAS Elements (optional)
TCLAS Processing Element (optional)
Number of D-SCS Profiles
Profile List
Optional Sub-elements

In FIG. 23, the Number of D-SCS Profiles field may indicate the number of QoS profiles included in the D-SCS Descriptor element. In other words, the Number of D-SCS Profiles field may indicate the number of Profile ID-QoS Duple included in the D-SCS Descriptor element.

In FIG. 23, the Profile List field in the D-SCS Descriptor element may contain one or more Profile ID-QoS Duple fields.

Although FIG. 23 illustrates one example 2300 of a format for a D-SCS profile element, various changes may be made to FIG. 23. For example, various changes to the fields could be made, etc. according to particular needs.

An example format for the Profile ID-QoS Duple field in FIG. 23 is shown in FIG. 24.

FIG. 24 illustrates an example 2400 of a format for a profile ID-QoS duple field according to embodiments of the present disclosure. The embodiment of a profile ID-QoS duple field of FIG. 24 is for illustration only. Different embodiments of a format for a profile ID-QoS duple field could be used without departing from the scope of this disclosure.

In the example of FIG. 24, the Profile ID-QoS Duple filed includes the following elements:
Profile ID
QoS Characteristics Element

Although FIG. 24 illustrates one example 2400 of a format for a profile ID-QoS duple field, various changes may be made to FIG. 24. For example, various changes to the fields could be made, etc. according to particular needs.

In some embodiments, the format of a D-SCS Request frame may be similar as shown in FIG. 24.

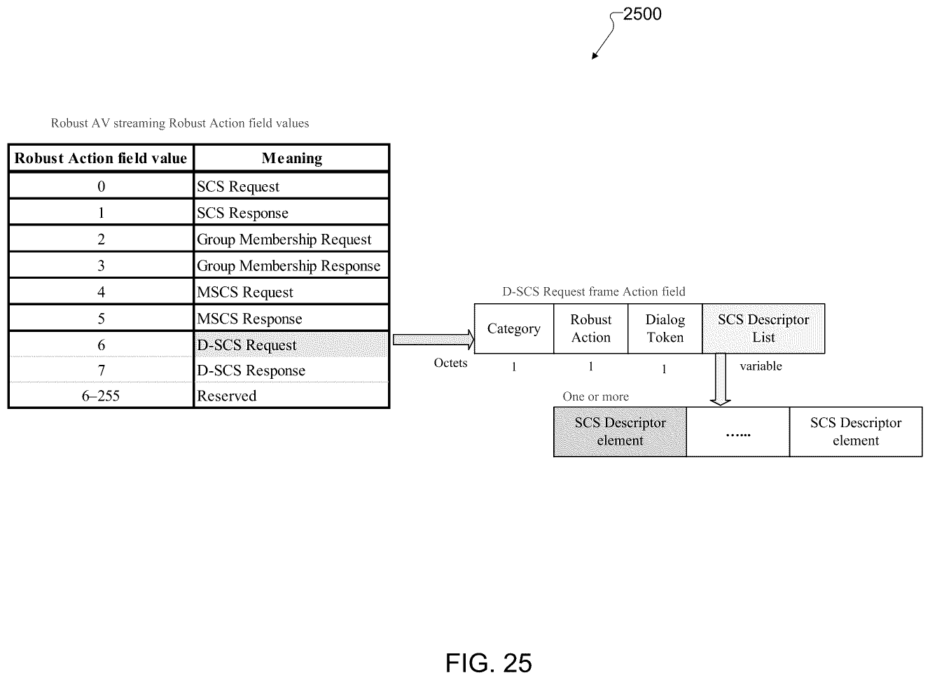

FIG. 25 illustrates another example 2500 of a format for a D-SCS request frame according to embodiments of the present disclosure. The embodiment of a D-SCS request frame of FIG. 25 is for illustration only. Different embodiments of a format for a D-SCS request frame could be used without departing from the scope of this disclosure.

In the example of FIG. 25, the D-SCS request frame includes the following elements:
Category
Robust Action
Dialog Token
SCS Descriptor List

In some embodiments, the SCS descriptor list in the D-SCS request frame can contain one or more SCS Descriptor elements, similar as shown FIG. 25.

Although FIG. 25 illustrates one example 2500 of a format for a D-SCS request frame, various changes may be made to FIG. 25. For example, various changes to the fields could be made, etc. according to particular needs.

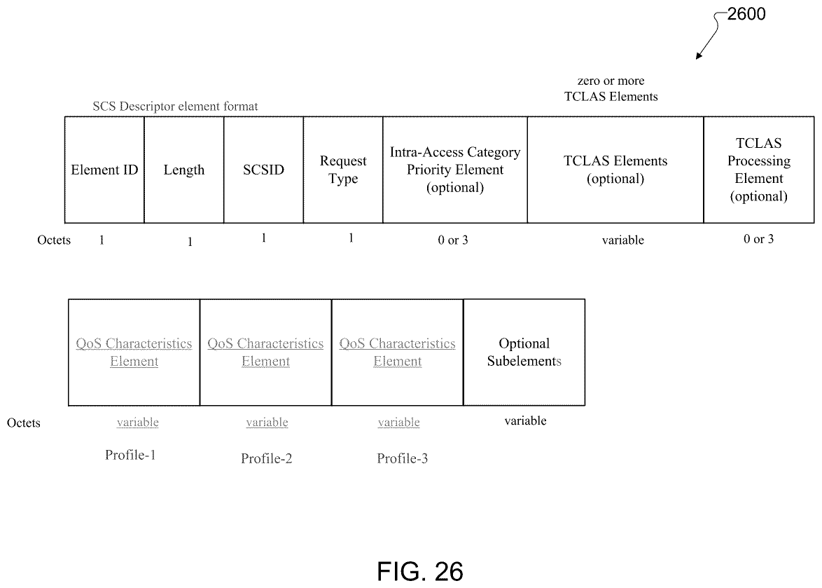

In some embodiments, in order to switch among multiple QoS profiles using Dynamic SCS procedure, in an SCS Request frame or in a D-SCS Request frame, there can be more than one QoS characteristics elements in the SCS descriptor element. Each QoS characteristics element may correspond to a QoS profile, where the STA can switch from one QoS profile to another QoS profile, similar as shown in FIG. 26.

FIG. 26 illustrates another example 2600 of a format for a D-SCS descriptor element according to embodiments of the present disclosure. The embodiment of a D-SCS descriptor element of FIG. 26 is for illustration only. Different embodiments of a format for a D-SCS descriptor element could be used without departing from the scope of this disclosure.

In the example of FIG. 26, the D-SCS descriptor element includes the following fields:
Element ID
Length
SCSID
Intra-Access Category Priority Element (optional)
TCLAS Elements (optional)
TCLAS Processing Element (optional)
A QoS characteristics element for each profile (in this example, Profile-1, Profile-1, and Profile-3)
Optional Sub-elements

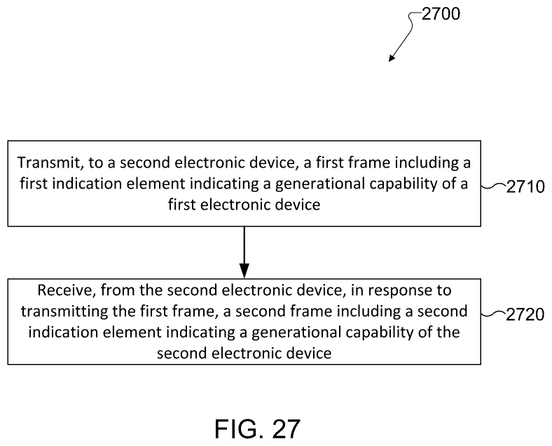

Although FIG. 26 illustrates one example 2600 of a format for a D-SCS descriptor element, various changes may be made to FIG. 27. For example, various changes to the fields could be made, etc. according to particular needs.

FIG. 27 illustrates an example method 2700 for extended usage of a protected management frame according to embodiments of the present disclosure. An embodiment of the method illustrated in FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments of a method for extended usage of a protected management frame could be used without departing from the scope of this disclosure.

In the example of FIG. 27, method 2700 begins at step 2710. At step 2710, a first electronic device (such as STA 502 [STA1] of FIG. 5) receives, from a second electronic device (such as AP 504 if FIG. 5), a first frame including a first indication element indicating a generational capability of the first electronic device.

In some embodiments, the first frame may be one of a probe request frame, an association request frame, and a reassociation request frame.

At step 2720, the first electronic device receives, from the second electronic device, in response to transmitting the first frame, a second frame including a second indication element indicating a generational capability of the second electronic device.

In some embodiments, prior to receiving the first frame, the first electronic device may receive a third frame from the second electronic device, and the first electronic device may transmit the first frame in response to receipt of the third frame.

In some embodiments, the second frame may be one of an association response frame or a reassociation response frame.

In some embodiments, at least one of the first frame and the second frame may be one of a PMF, a robust action frame, and a robust management frame protected by a management frame protection service.

In some embodiments, one or more of the first indication element and the second indication element may indicate at least one of (i) an IEEE generational capability indicating one or more different supported IEEE generations, (ii) a WFA generational capability indicating one or more different supported WFA generations, and (iii) a WFA generational certification status indicating one or more different WFA generational certifications.

In some embodiments, the one or more different supported IEEE generations may be indicated in a generational capability bitmap. In some embodiments, the one or more different supported WFA generations may be indicated in a WFA generational support bitmap. In some embodiments, the one or more different WFA generational certifications may be indicated in a WFA generation certification bitmap.

Although FIG. 27 illustrates one example method 2700 for extended usage of a protected management frame, various changes may be made to FIG. 27. For example, while shown as a series of steps, various steps in FIG. 27 could overlap, occur in parallel, occur in a different order, occur any number of times, be omitted, or replaced by other steps.

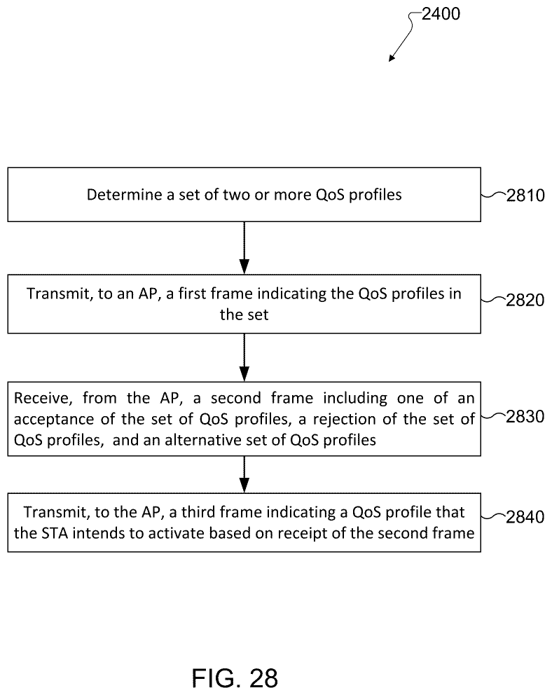

FIG. 28 illustrates an example method 2800 for a dynamic stream classification service request according to embodiments of the present disclosure. An embodiment of the method illustrated in FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of a method a dynamic stream classification service request could be used without departing from the scope of this disclosure.

In the example of FIG. 28, method 2800 begins at step 2810. At step 2810, a STA (such as STA 1704 of FIG. 17), may determine a set of two or more QoS profiles.

At step 2820, the STA may transmit, to an access point (such as AP 1702 of FIG. 17), a first frame indicating the QoS profiles in the set.

In some embodiments, the first frame may be an SCS request frame. In some embodiments, the QoS profiles in the set may be indicated in an SCS descriptor list of the SCS request frame. The SCS descriptor list may include an SCS descriptor element for each of the QoS profiles in the set.

In some embodiments, the first frame may be a D-SCS request frame. In some embodiments, the QoS profiles in the set may be indicated in a D-SCS descriptor list of the D-SCS request frame. The D-SCS descriptor list may include a D-SCS descriptor element for each of the QoS profiles in the set.

At step 2830, the STA may receive, from the AP, a second frame including one of an acceptance of the set of QoS profiles, a rejection of the set of QoS profiles, and an alternative set of QoS profiles. In some embodiments, the second frame may be an SCS response frame. In some embodiments, the second frame may be a D-SCS response frame.

At step 2840, the STA transmits, to the AP, a third frame indicating a QoS profile that the STA intends to activate based on receipt of the second frame. In some embodiments, the third frame may be a control frame indicating at least one of a profile ID and an SCS ID corresponding with the QoS profile that the STA intends to activate. In some embodiments, the third frame may be a QPI frame.

Although FIG. 28 illustrates one example method 2800 for a dynamic stream classification service request, various changes may be made to FIG. 28. For example, while shown as a series of steps, various steps in FIG. 28 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A first electronic device comprising:
a processor; and
a transceiver operably coupled to the processor, the transceiver configured to:
transmit, to a second electronic device, a first frame including a first indication element indicating a generational capability of the first electronic device; and
receive, from the second electronic device, in response to transmitting the first frame, a second frame including a second indication element indicating a generational capability of the second electronic device.

2. The first electronic device of claim 1, wherein one or more of the first indication element and the second indication element indicate at least one of:
an Institute of Electrical and Electronics Engineers (IEEE) generational capability indicating one or more different supported IEEE generations;
a WiFi Alliance (WFA) generational capability indicating one or more different supported WFA generations; and
a WFA generational certification status indicating one or more different WFA generational certifications.

3. The first electronic device of claim 2, wherein the one or more different supported IEEE generations are indicated in a generational capability bitmap.

4. The first electronic device of claim 2, wherein:
the one or more different supported WFA generations are indicated in a WFA generational support bitmap; and
the one or more different WFA generational certifications are indicated in a WFA generation certification bitmap.

5. The first electronic device of claim 1, wherein:
the first frame is one of:
a probe request frame;
an association request frame; and
a reassociation request frame; and
the second frame is one of an association response frame or a reassociation response frame.

6. The first electronic device of claim 1, wherein at least one of the first frame and the second frame is one of:
a protected management frame (PMF);
a robust action frame; and
a robust management frame protected by a management frame protection service.

7. The first electronic device of claim 1, wherein:
the transceiver is further configured to, prior to transmitting the first frame, receive a third frame from the second electronic device; and
the first frame is transmitted in response to receipt of the third frame.

8. The first electronic device of claim 1, wherein:
the first electronic device is one of a first access point (AP) and a first non-AP station (STA); and
the second electronic device is one of a second AP and a second non-AP STA.

9. A station (STA) comprising:
a processor configured to determine a set of two or more quality of service (QoS) profiles; and
a transceiver operably coupled to the processor, the transceiver configured to:
transmit, to an access point (AP), a first frame indicating the QoS profiles in the set; and
receive, from the AP, a second frame including one of:
an acceptance of the set of QoS profiles;
a rejection of the set of QoS profiles; and
an alternative set of QoS profiles; and
transmit, to the AP, a third frame indicating a QoS profile that the STA intends to activate based on receipt of the second frame.

10. The STA of claim 9, wherein the third frame is a control frame indicating at least one of a profile ID and an SCS ID corresponding with the QoS profile that the STA intends to activate.

11. The STA of claim 9, wherein:
the first frame is a stream classification services (SCS) request frame;
the second frame is an SCS response frame; and
the third frame is a QoS profile indication (QPI) frame.

12. The STA of claim 11, wherein the QoS profiles in the set are indicated in an SCS descriptor list of the SCS request frame, the SCS descriptor list including an SCS descriptor element for each of the QoS profiles in the set.

13. The STA of claim 9, wherein:
the first frame is a dynamic-stream classification services (D-SCS) request frame;
the second frame is a D-SCS response frame; and
the third frame is a QoS profile indication (QPI) frame.

14. The STA of claim 13, wherein the QoS profiles in the set are indicated in a D-SCS descriptor list of the D-SCS request frame, the D-SCS descriptor list including a D-SCS descriptor element for each of the QoS profiles in the set.

15. An access point (AP) comprising:
a transceiver configured to receive, from a station (STA), a first frame indicating a set of two or more quality of service (QoS) profiles; and
a processor operably coupled to the transceiver, the processor configured to one of:
accept the set of QoS profiles;
reject the set of QoS profiles; and
identify an alternative set of QoS profiles,
wherein the transceiver is further configured to:
transmit, to the STA, a second frame including one of:
an acceptance of the set of QoS profiles;
a rejection of the set of QoS profiles; and
the alternative set of QoS profiles; and
receive, from the STA, a third frame indicating a QoS profile that the STA intends to activate based on the second frame.

16. The AP of claim 15, wherein the third frame is a control frame indicating at least one of a profile ID and an SCS ID corresponding with the QoS profile that the STA intends to activate.

17. The AP of claim 15, wherein:
the first frame is a stream classification services (SCS) request frame;
the second frame is an SCS response frame; and
the third frame is a QoS profile indication (QPI) frame.

18. The AP of claim 17, wherein the QoS profiles in the set are indicated in an SCS descriptor list of the SCS request frame, the SCS descriptor list including an SCS descriptor element for each of the QoS profiles in the set.

19. The AP of claim 15, wherein:
the first frame is a dynamic-stream classification services (D-SCS) request frame;
the second frame is a D-SCS response frame; and
the third frame is a QoS profile indication (QPI) frame.

20. The AP of claim 19, wherein the QoS profiles in the set are indicated in a D-SCS descriptor list of the D-SCS request frame, the D-SCS descriptor list including a D-SCS descriptor element for each of the QoS profiles in the set.
